(19) United States
(12) Patent Application Publication
(10) Pub. No.: US 2005/0255263 A1
(43) Pub. Date: Nov. 17, 2005

(54) Vinylidene chloride polymer compositions and food casings made therefrom

(76) Inventors: Eric K. C. Lee, Midland, MI (US); Rene Kruidenier, Tarragona (ES)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/529,052

(22) PCT Filed: Oct. 14, 2003
(86) PCT No.: PCT/US03/32395

§ 371 Date: Mar. 24, 2005

Related U.S. Application Data
(60) Provisional application No. 60/421,029, filed on Oct. 24, 2002.

(51) Int. Cl. A22C 13/00

(52) U.S. Cl. 428/34.8

(57) ABSTRACT

The present invention is a poly(vinylidene chloride) interpolymer composition comprising (1) a copolymer of an alpha olefin and an alkyl ester of an unsaturated carboxylic acid and (2) an interpolymer of vinylidene chloride and vinyl chloride, the copolymer being present in an amount effective to improve meat adhesion of a food casing made from the interpolymer composition having the copolymer as compared with a composition having the same proportions of components as the interpolymer composition but without the added copolymer (hereinafter effective amount). Preferably, the copolymer comprises ethylene and at least one alkyl ester of an unsaturated carboxylic acid. The invention is also a process for preparing a thermoplastic food casing which comprises adding an effective amount of a copolymer of an alpha olefin and an alkyl ester of an unsaturated carboxylic acid to a an interpolymer of vinylidene chloride and vinyl chloride to improve meat adhesion of the food casing. Additionally, the invention is a film comprising an interpolymer of vinylidene chloride and vinyl chloride and an effective amount of a copolymer of an alpha olefin and an alkyl ester of an unsaturated carboxylic acid. The film is preferably used in applications for contacting meat. Additionally, the invention is a combination of a film comprising an interpolymer of vinylidene chloride and vinyl chloride and an effective amount of a copolymer of an alpha olefin and an alkyl ester of an unsaturated carboxylic acid and, adjacent thereto or in contact therewith, a fatty substance, preferably a meat having a fat content, meat product having fat content, or other food having a fat content. In another aspect, the invention is a package useful for meats or other fatty substances comprising an interpolymer of vinylidene chloride and vinyl chloride and an effective amount of a copolymer of an alpha olefin and an alkyl ester of an unsaturated carboxylic acid wherein the package is designed for contact of interpolymer of vinylidene chloride with the meat or fatty substance. In another aspect, the invention is a sausage casing having a film comprising an interpolymer of vinylidene and chloride vinyl chloride and an effective amount of a copolymer of an alpha olefin and an alkyl ester of an unsaturated carboxylic acid. In yet another aspect, the invention is the use of a vinylidene chloride interpolymer composition comprising and interpolymer of vinylidene chloride and vinyl chloride and an effective amount of at least one copolymer of an alpha olefin and an alkyl ester of an ethylenically unsaturated carboxylic acid in a composition suitable for making a film, the resulting film, a molded article, a package, in each case preferably suitable for contacting or containing a fatty substance or food, preferably in a sausage casing.

### CROSS REFERENCE STATEMENT

This application claims the benefit of U.S. Provisional Application No. 60/421,029, filed Oct. 24, 2002.

### BACKGROUND OF THE INVENTION

This invention relates to thermoplastic films used for packaging items in general, and for packaging fatty substances or foods, such as meat and cheese sausages, in particular. With respect to a particular embodiment, one of the key performance requirements for sausage casings made from thermoplastic polymers is a sufficient degree of meat adhesion between the sausage meat and the inside surface of the sausage casing. Insufficient adhesion is evidenced by a separation of the meat from the inside surface of the casing, which leads to the formation of spaces or pockets between the sausage mass and the inside surface of the casing. When such spaces or pockets are present, fluids, fat and gelatinous materials from the meat sometimes accumulate in such spaces, resulting in a non-uniform sausage appearance, which is unappetizing and undesirable to consumers. The accumulated fluids and fat also can contribute to ease of spoilage of the sausage meat during storage. The term “meat adhesion” is used for the property that avoids this separation of meat or fatty substance from the surface contacting the meat or fatty substance.

It is known that sausage casings made from a typical poly(vinylidene chloride) copolymer resin formulation, sometimes evidence insufficient meat adhesion when used to package sausage meat with a high fat content.

The term “typical poly(vinylidene chloride) copolymer resin formulation” means a formulation which is at least 50 weight percent copolymer of vinylidene chloride copolymerized with vinyl chloride, or alkyl acrylates, alkyl methacrylates, acrylic acid, methacrylic acid, itaconic acid, acrylonitrile, methacrylonitrile, and the like with additives commonly used to avoid deterioration in the copolymer. and optionally other additives not specifically designed to address close contact or adhesion to fatty substances. In this invention copolymers of vinylidene chloride with vinyl chloride are of particular interest for comparison.

It would be desirable to provide a poly(vinylidene chloride) copolymer resin composition suitable for close contact with fatty substances, most preferably for making sausage casings which fit tightly about the encased food product and avoid observably obvious separation from the fatty substance or sausage exhibited by a typical copolymer of vinylidene chloride, particularly a vinylidene chloride copolymerized with vinyl chloride.

There have been some attempts to solve this problem. For instance, JP 49090339 teaches addition of ethylene-methacrylic acid copolymer Na salt (an ionomer) into a certain vinylidene chloride copolymer film formulation for improved meat adhesion. However, compatibility of the ionomer with the poly(vinylidene chloride) copolymer is usually low, leading to a lowering of physical and optical properties of the film. Similarly Canadian Patent 2038757 teaches adding certain copolymers of alpha olefin and unsaturated carboxylic acid into specified vinylidene chloride copolymer film formulations for improved meat adhesion. However, compatibility of these copolymers with poly(vinylidene chloride) copolymers are usually low, leading to detrimental effects in physical and optical properties of the film. Also carboxylic acid group containing copolymers often result in more difficulty sealing a film. EP 29316 teaches adding certain butyl methacrylate-methyl methacrylate-monobutyl itaconate copolymers into specified vinylidene chloride copolymer formulations for improved meat adhesion. As mentioned, carboxylic acid group containing copolymers often increase difficulty of sealing a resulting film. Several references mention adding certain polymers of hydroxyl alkyl esters of acrylic or methacrylic acid such as hydroxypropyl methacrylate into specified vinylidene chloride copolymer compositions to improve meat adhesion. These references include JP 49074233 and JP 49074232. Hydroxy functional esters of acrylic acids have the disadvantage of limited compatibility with vinylidene chloride copolymers. A different approach is taken in the teachings of JP 46042941, where vinylidene chloride is copolymerized with unsaturated organic acid glycidyl ester for improved meat adhesion. Disadvantages of this process include requiring use of a chemical reaction to incorporate the effective component, adding to the cost and complexity of the method of meat adhesion modification of a resulting poly(vinylidene chloride) film. Another process is taught in Japanese Patent Application KOKAI N. P2000-309656 where a certain methyl methacrylate/butyl acrylate/styrene copolymer is added into a specified vinylidene chloride copolymer formulation, which is formed into a film and afterwards treated with low level corona discharge to obtain improved meat adhesion. The additional steps and corona discharge complicate this process as compared with simple formulations with adhesion additives. Furthermore, this process requires that the modification of the film take place after the film is formed rather than by the distributor of the formulation. It is less suitable for situations where more than one layer of the treated film might be used adjacently because the layers would be separated and treated before being recombined.

It is also known to combine certain copolymers of vinylidene chloride and methyl acrylate with ethylene methyl acrylate and other specified additives as the barrier layer coating on a multilayer film, for instance in the teachings of U.S. Pat. No. 5,604,043. This reference teaches formation of a multilayer film, irradiation of the film and extrusion coating with the barrier layer composition. This multistep process is disadvantageous as explained for other multistep processes as compared with formation of simple admixtures. The formation of several layers of different composition is also disadvantageous, because it requires specialized equipment and expertise that can be inappropriate for such situations as simple sausage making industries.

### SUMMARY OF THE INVENTION

In a first aspect, the present invention is a poly(vinylidene chloride) interpolymer composition comprising (1) a copolymer of an alpha olefin and an alkyl ester of an unsaturated carboxylic acid and (2) an interpolymer of vinylidene chloride and vinyl chloride, the copolymer being present in an amount effective to improve meat adhesion of a food casing made from the interpolymer composition having the copolymer as compared with a composition having the same proportions of components as the interpolymer composition but without the added copolymer (hereinafter effective amount). Preferably, the copolymer comprises ethylene and at least one alkyl ester of an unsaturated carboxylic acid.

Meat adhesion of a food casing is measured by the weight of meat that remains attached to a unit area of the contacting film surface as described in Example 1 of the invention hereinafter.

In a second aspect, the present invention is a process for preparing a thermoplastic food casing which comprises adding an effective amount of a copolymer of an alpha olefin and an alkyl ester of an unsaturated carboxylic acid to a an interpolymer of vinylidene chloride and vinyl chloride to improve meat adhesion of the food casing.

In another aspect, the invention is a film comprising an interpolymer of vinylidene chloride and vinyl chloride, and an effective amount of a copolymer of an alpha olefin and an alkyl ester of an unsaturated carboxylic acid. The film is preferably used in applications for contacting meat.

In another aspect, the invention is a combination of a film comprising an interpolymer of vinylidene chloride and vinyl chloride, and an effective amount of a copolymer of an alpha olefin and an alkyl ester of an unsaturated carboxylic acid and, adjacent thereto or in contact therewith, a fatty substance, preferably a meat having a fat content, meat product having fat content, or other food having a fat content.

In another aspect, the invention is a package useful for meats or other fatty substances comprising an interpolymer of vinylidene chloride and vinyl chloride, and an effective amount of a copolymer of an alpha olefin and an alkyl ester of an unsaturated carboxylic acid wherein the package is designed for contact of interpolymer of vinylidene chloride with the meat or fatty substance.

In another aspect, the invention is a sausage casing having a film comprising an interpolymer of vinylidene chloride and vinyl chloride and an effective amount of a copolymer of an alpha olefin and an alkyl ester of an unsaturated carboxylic acid.

In another aspect, the invention is the use of a vinylidene chloride interpolymer composition comprising an interpolymer of vinylidene chloride and vinyl chloride and an effective amount of at least one copolymer of an alpha olefin and an alkyl ester of an ethylenically unsaturated carboxylic acid in a composition suitable for making a film, the resulting film, a molded article, a package, in each case preferably suitable for contacting or containing a fatty substance or food, preferably in a sausage casing.

In all aspects of the invention involving a film, the film is preferably a monolayer film.

The term “fatty substance” is used to denote a material having chemical, physical, and/or tactile properties commonly associated with fat as well as any material having a fat content.

The term “fat content” is used to denote presence of a measurable quantity of fatty acid esters, a special naturally occurring class of which is triglycerides, both saturated and unsaturated, commonly found in edible fats and oils. Preferably, the fat content is present as an integral element of a processed meat such as a sausage. This fat content is optionally a naturally occurring part of the meat component, or alternatively an added ingredient into the meat composition. Measurement of fat content is within the skill in the art for instance in measuring nutritional content for labeling. In the practice of the invention, the fat content is preferably sufficient to result in separation of the substance having the fat content from a vinylidene chloride interpolymer in the substantial absence of the copolymer of olefin and alkyl unsaturated carboxylic acid ester as used in the practice of the invention under conditions which can be encountered in the course of use of the interpolymer. Substantial absence is an amount less than that effective for practice of the invention, preferably an amount present that might be present incidentally, e.g. as a contaminant in another additive, without deliberate addition of the copolymer of olefin and alkyl unsaturated carboxylic acid ester.

### DETAILED DESCRIPTION OF THE INVENTION

Vinylidene chloride polymers (also known as vinylidene chloride resins, interpolymers of vinylidene chloride, copolymers of vinylidene chloride, and PVDC) are well-known in the art. See, for example, U.S. Pat. Nos. 3,642,743 and 3,879,359. PVDC resins known as Saran™ resins, manufactured by The Dow Chemical Company are commercially available, as are many other types of vinylidene chloride interpolymers such as PVDC copolymer resins supplied by Kureha Chemical Industry Co. Ltd of Japan. As used herein, the term “interpolymer of vinylidene chloride,” vinylidene chloride interpolymer” or “PVDC” encompasses copolymers, terpolymers, and higher polymers wherein the major component is vinylidene chloride and the remainder is one or more monoethylenicly unsaturated monomer copolymerizable with the vinylidene chloride monomer such as vinyl chloride, alkyl acrylates, alkyl methacrylates, acrylic acid, methacrylic acid, itaconic acid, acrylonitrile, methacrylonitrile, and the like. For use in the practice of the invention, an interpolymer of vinylidene chloride vinyl chloride is preferred. The interpolymer optionally contains one or more other unsaturated monomers as previously described, preferably in amounts less than the amount of vinyl chloride (on a weight basis). Such interpolymers are suitable for mono-layer film formation in a blown film process. In contrast, vinylidene chloride interpolymers not having vinyl chloride comonomers often require adjacent layers of film for commercial film formation.

Preferably, the vinylidene chloride interpolymer is formed from a monomer mixture comprising a vinylidene chloride monomer advantageously in an amount from about 50 to about 99.9 weight percent and the monoethylenically unsaturated comonomer in an amount from 0.1 up to about 50, weight percent, said weight percents being based on total weight of the vinylidene chloride interpolymer. More preferably, the amount of monoethylenically unsaturated monomer is from less than or equal to about 40 most preferably less than or equal to about 25 weight percent, and at least about 4, more preferably at least about 10 weight percent based on total weight of the vinylidene chloride polymer. In the practice of the present invention at least about 50 weight percent of the unsaturated monomer copolymerized with vinylidene chloride is vinyl chloride, preferably 60, more preferably 75, most preferably 100 weight percent.

Copolymers of olefins and alkyl esters of unsaturated carboxylic acids are known in the art and commercially available such as the ethylene methyl acrylate copolymers and ethylene butyl acrylate copolymers commercially available from Eastman Chemical Company under the trade designations EMAC, EMAC+, EBAC and EBAC+ with numeric designations beginning with the letters SP, such as SP 2255, SP2258, SP2205, SP1400, SP 1307, and SP 1903. Preferred olefins are alpha olefins, that is ethylenically unsaturated compounds having a single double bond in the alpha or first position. Of the alpha olefins, preferably C₂-C₂₀, more preferably C₂-C₁₀ alpha olefins; ethylene is most preferred; other alpha olefins include propylene, 1-butene, 1-pentene, 1-hexene, 1-heptene, 1-octene and the like. Among effective alkyl esters of unsaturated carboxylic acids, the alkyl esters of acrylic and methacrylic acid are preferred, with acrylates more preferred. Of the alkyl esters, straight chain alkyl groups are preferred, with sizes of C₁ to C₂₀ preferred, C₁ to C₄ alkyl groups more preferred and methyl groups most preferred. The copolymers are optionally, but not preferably, terpolymers or higher polymers, having up to about 30, advantageously less than about 20, preferably less than about 10, more preferably less than about 5, most preferably less than about 3 weight percent of at least one other ethylenically unsaturated monomer interpolymerized therewith. These optional monomers include styrene, acrylonitrile, methyl methacrylate, acrylic acid, methacrylic acid, vinyl acetate, and the like. Methyl acrylate is the most preferred alkyl ester. The copolymer advantageously has at least about 1, more preferably at least about 20 weight percent alkyl ester based on total weight of the copolymer of olefin and alkyl ester of unsaturated carboxylic acid. While up to about 50 weight percent or more alkyl ester is useful, more preferably less than or equal to 40, most preferably less than about 30 weight percent alkyl ester is present in the copolymer to achieve a good balance of high meat adhesion enhancement and low extractability of the copolymer of olefin and ester into the fat of a packaged meat or similar product. For use in compositions from which films for food contact are to be made, it is advantageous that the level of alkyl acrylate in the olefin-alkyl acrylate copolymer to be lower than about 30 percent by weight to reduce its extractability into fat.

Advantageously, the copolymer is selected for its processability, that is ease of extrusion under conditions commonly used in the Industry and width of temperature window in which extrusion can take place, its compatibility to avoid obvious segregation in the melt with the vinylidene chloride interpolymer, and its effectiveness in promoting adhesion of the resulting composition to meat, as well as a low degree of extractability into fat or fat content. Processing and compatibility with the interpolymer is enhanced by using copolymers of an olefin and alkyl ester of an unsaturated carboxylic acid having a melt index of at least about 0.1, preferably 0.5, more preferably at least about 1, and advantageously less than about 500, preferably less than about 10, more preferably less than about 6, most preferably about 2, e.g. in the range of 1.5 to 2.5 g/10 min.

While the optimum amount of olefin/alkyl ester copolymer in the vinylidene chloride Interpolymer varies with the identity and characteristics of the copolymer and interpolymer, any amount sufficient to achieve improved adhesion between the resulting interpolymer composition and a fatty substance, especially meat or a meat product is suitable for practice of the invention. These amounts are frequently at least about 0.1 weight percent olefin/alkyl ester copolymer in the vinylidene chloride interpolymer based on weight of the interpolymer. Preferably at least about 1 weight percent olefin/alkyl ester copolymer is used in the interpolymer composition. While up to about 50 weight percent of the olefin/alkyl ester copolymer is useful in the practice of the invention, preferably less than about 30, more preferably less than about 10, most preferably less than about 3 weight percent of olefin/alkyl ester copolymer based on weight of the vinylidene chloride interpolymer would be used because of an optimal balance between enhanced meat adhesion and a low degree of negative impact on barrier and optical properties of the film. Barrier properties are those properties associated with a vinylidene chloride and vinyl chloride polymer film by those skilled in the art such as low permeation of water, odor and oxygen.

The vinylidene chloride interpolymer composition is conveniently prepared by blending the vinylidene chloride interpolymer and the copolymer of olefin and alkyl ester of unsaturated carboxylic acid using melt-processing equipment such as heated two-roll compounding mills, single screw extruders, twin screw extruders and the like. Blending techniques are well within the skill in the art.

A variety of additives within the skill in the art are optionally also incorporated into the vinylidene chloride interpolymer composition. Additive type and amount will depend upon several factors. One such factor is the intended use of the composition. A second factor is tolerance of the composition for the additives. That is, amount of additive that can be added before physical properties of the blends are adversely affected to an unacceptable level. Other factors are apparent to those skilled in the art of polymer formulation and compounding.

Exemplary additives include plasticizers, heat stabilizers, pigments, processing aids, lubricants, fillers, antioxidants, and the like. Each of these additives is within the skill in the art and several types of each are commercially available.

Exemplary lubricants include fatty acids, such as stearic acid; esters, such as fatty esters, wax esters, glycol esters, fatty alcohol esters and the like; fatty alcohols, such as n-stearyl alcohol; fatty amides, such as N,N′-ethylene bis stearamide; metallic salt of fatty acids, such as calcium stearate, magnesium stearate, and the like; and polyolefin waxes, such as paraffinic, and oxidized polyethylene and the like. Paraffin and polyethylene waxes and their properties and synthesis are described in 24 Kirk-Othmer Encyc. Chem. Tech. 3rd Ed., Waxes, at 473-77 (J. Wiley & Sons 1980), which is incorporated herein by reference.

The additives are conveniently incorporated into the vinylidene chloride interpolymer composition using melt-processing, dry blending techniques for thermally sensitive polymers or other means within the skill in the art.

The vinylidene chloride interpolymer compositions of the present invention are particularly suited for fabrication into flexible and rigid containers both in monolayer and multilayer structures used for the preservation of food, drink, medicine and other perishables. Such containers advantageously have mechanical properties considered suitable for the respective end uses, as well as low permeability to disadvantageous materials, which materials vary with the end use, for example, oxygen, carbon dioxide, water vapor, odor bodies or flavor bodies, hydrocarbons or agricultural chemicals. The containers of the invention are preferably used for fatty substances, preferably foods having a fat content, more preferably for meats, especially ground or processed meats such as sausages, cold cuts, and the like. In a preferred embodiment, the vinylidene chloride interpolymer composition is In the form of a film. The film advantageously has a thickness of at least about 3 micron (3×10⁻⁶ m), more preferably at least about 10 micron (10×10⁻⁶ m), most preferably at least about 30 micron (30×10⁻⁶ m). To achieve sufficient barrier properties without using unnecessary polymer and ease of processability, the film is advantageously less than about 120 micron (120×10⁻⁶ m), preferably less than about 70 micron (70×10⁻⁶ m), more preferably less than about 60 micron (60×10⁻⁶ m), most preferably less than about 50 micron (50×10⁻⁶ m) thick.

The vinylidene chloride interpolymer compositions of the present invention are more particularly suited for fabrication into sausage casings.

Preferably, the films of the invention are monolayer films because of simplicity of a structure, which provides the needed physical and barrier properties of a sausage covering film. A film Is considered monolayer even when two or more films are used together in an end use when those two films are not adhered to one another and not coextruded, but might be used, for instance, one as an overwrap of the other or as two layers collapsed together. Important physical properties include optical properties such as transparency and haze, film surface properties such as coefficient of friction and block strength, and performance properties such as toughness and rigidity.

The monolayer structures comprise the vinylidene chloride interpolymer composition of the present invention and are conveniently made by blown film process within the skill in the art. Blown film extrusion processes are known and are described, for example, in U.S. Pat. Nos. 2,409,521, 2,476,140, 2,634,459, 3,750,948, 4,997,616, 5,213,725, and 5,700,489. In an exemplary blown film extrusion process, commonly known as the “double bubble” process, a molten thermoplastic polymer is extruded through a tubular die. The extruded molten polymer exits the die and is quenched in a cold water bath into an amorphous polymer tube. This amorphous polymer tube is collapsed into a tape and then passed through a second warm water tank for conditioning prior to being formed into a bubble or blown film by the pressure of internal air in a bubble. The blown film is collapsed into a flat web, which is optionally split to form two layers of film.

The present invention is illustrated in further detail by the following example. The example is for the purposes of illustration only, and is not to be construed as limiting the scope of the present invention. All parts and percentages are by weight unless otherwise specifically noted.

### EXAMPLE 1

A 98 lb (36 kg) sample of a vinylidene chloride interpolymer of 80 weight percent vinylidene chloride and 20 weight percent vinyl chloride commercially available from The Dow Chemical Company under the trade designation Saran™ 2032 PVDC copolymer and a 2 lb (0.7 kg) sample of a poly(ethylene methyl acrylate) having 24 weight percent methyl acrylate in the polymer, commercially available from Eastman Chemical Company under the trade designation SP2260, are admixed in a high speed blade type blender at room temperature to make a blend, which is a vinylidene chloride interpolymer composition containing 2.0 weight percent ethylene/methyl acrylate. This blend is then extruded using a “double bubble” blown film process, as previously described, into a film. (The extruder used is a 1.5 inch diameter single screw extruder with 17 L/D ratio (length to diameter ratio). The extrusion conditions are as follows:

Extruder Barrel Temperature: 170° C.

Die Temperature: 155° C.

Screw rpm: 48.5

First Water Bath Temperature: 18° C. The first water bath surrounds the extrudate from the die.

Second Water Bath Temp: 34° C. The second water bath surrounds the collapsed tube from the first water bath.

Tape Width: 150 mm

Film Width: 650 mm

Blow Up Ratio: 4.36

Film thickness: 200 gauge (converted to SI units is 50.8 micron (50.8×10⁻⁶ m))

In this extruder a tube of 95.5 mm diameter is formed and then blown to a bubble of 414 mm diameter. The bubble is collapsed into a web of 650 mm width. The edges of the web are removed and the web is slit into 5 webs each about 130 mm wide and rolled onto separate paper cores, and stored at 23° C. and 50 percent relative humidity for about 48 hours.

After a period of 48 hours at 23° C., the resulting film is sealed using radio frequency sealing into the form of a tube of about 3 meters in length and 30 mm in diameter. Sections 15 cm in length of the tubes are then made into “sausages” (chub shaped bodies having a filling containing a food-like or food simulating material having a fat content) by filling them with an artificial meat mixture of the following composition:

1.1% Oil (50/50 blend of Canola oil and, Soybean oil)

36.0% Wheat Flour

54.0% Water

9.0% Albumin Egg Powder

The ends of the chubs are tied closed with strings. The “sausages” are then cooked in boiling water for 15 minutes and then cooled for a period of 2 hrs at 23° C. After cooling to room temperature, sections of the film covering the “sausages” are cut off and the artificial “meat” adhering to the film measured. The measuring process involves weighing the peeled film with artificial meat immediately after peeling (W1). Next, the artificial meat is washed off completely. The film is then pat dried and then left to air dry for about 2 hrs and weighed again (W2). The amount of meat adhered is calculated by the difference (W1−W2). The area of the film used is measured, and the meat adhesion is calculated by dividing the weight of meat adhered to the film by the area of the film and reported as meat adhesion in units of mg/cm². The following are the results of the meat adhesion measured:
Meat Adhesion of Film of the Invention: 1.75 mg/cm²

### COMPARATIVE EXAMPLE A

The process of Example 1 is repeated using the same vinylidene chloride/vinyl chloride interpolymer but without the added copolymer of ethylene and an alkyl ester of an unsaturated carboxylic acid to make the film.

Meat adhesion is measured to be 0.87 mg/cm².

These results show that an olefin-alkyl acrylate copolymer increases the meat adhesion of vinylidene chloride/vinyl chloride interpolymer film.

1. A poly(vinylidene chloride) interpolymer composition comprising (1) a copolymer of an alpha olefin and an alkyl ester of an unsaturated carboxylic acid and (2) an interpolymer of vinylidene chloride and vinyl chloride, the copolymer being present in an amount effective to improve meat adhesion of a food casing made from the interpolymer composition having the copolymer as compared with a composition otherwise having the same proportions of components as the interpolymer composition but without the added copolymer (hereinafter effective amount).

2. A process for preparing a thermoplastic food casing which comprises adding an effective amount of a copolymer of an alpha olefin and an alkyl ester of an unsaturated carboxylic acid to a an interpolymer of vinylidene chloride and vinyl chloride to improve meat adhesion of the food casing.

3. A film comprising (1) an interpolymer of vinylidene chloride and vinyl chloride and (2) an effective amount of a copolymer of an alpha olefin and an alkyl ester of an unsaturated carboxylic acid to improve meat adhesion of the film.

4. A combination of (1) a film comprising (a) an interpolymer of vinylidene chloride and vinyl chloride and (b) an effective amount of a copolymer of an alpha olefin to improve meat adhesion and an alkyl ester of an unsaturated carboxylic acid and, adjacent thereto or in contact therewith, (2) a fatty substance, a meat having fat content, a meat product having fat content, or other food having fat content.

5. A package to contact meat or other fatty substance wherein the meat or fatty substance contacts a surface comprising (1) an interpolymer of vinylidene chloride and vinyl chloride and (2) an effective amount of a copolymer of an alpha olefin and an alkyl ester of an unsaturated carboxylic acid to improve meat adhesion.

6. The package of claim 5 wherein the surface is a surface of a film.

7. A package useful for meat or other fatty substance comprising (1) an interpolymer of vinylidene chloride and vinyl chloride and (2) an effective amount of a copolymer of an alpha olefin and an alkyl ester of an unsaturated carboxylic acid to improve meat adhesion wherein the package is designed for contact of interpolymer of vinylidene chloride with the meat or fatty substance.

8. A sausage casing having a film comprising (1) an interpolymer of vinylidene and chloride vinyl chloride and (2) an effective amount of a copolymer of an alpha olefin and an alkyl ester of an unsaturated carboxylic acid to improve meat adhesion.

9. A use of a vinylidene chloride interpolymer composition comprising (1) an interpolymer of vinylidene chloride and vinyl chloride and (2) an effective amount of at least one copolymer of an alpha olefin and an alkyl ester of an ethylenically unsaturated carboxylic acid to improve meat adhesion for making a film, a molded article, a package or packaging material.

10. The use of claim 9 wherein the film, article, package or packaging is suitable for contacting or containing a fatty substance or food.

11. The use of claim 10 wherein the fatty substance or food is sausage.

12. The invention of any of claims 1-11 wherein there is a film, the film is a monolayer film.

13. The film of claim 12 used to contact meat.

14. The invention of any of claims 1-13 wherein the copolymer comprises ethylene and at least one alkyl ester of an acrylic or methacrylic acid.

15. The invention of any of claims 1-14 wherein the copolymer comprises ethylene and at least one C₁ to C₁₀ alkyl ester of acrylic acid.

16. The invention of any of claims 1-15 wherein the copolymer comprises ethylene and methyl ester of acrylic acid

17. The invention of any of claims 1-16 wherein the copolymer comprises from 1 to 50 weight percent alkyl ester of unsaturated carboxylic acid.

18. The invention of any of claims 1-17 wherein the copolymer comprises from 20 to 30 weight percent alkyl ester of unsaturated carboxylic acid.

19. The invention of any of claims 1-18 wherein the copolymer has a melt index of from 0.1 to 500 gm/10 min.

20. The invention of any of claims 1-19 wherein the copolymer has a melt index of from 1 to 6 gm/10 min.

21. The invention of any of claims 1-20 wherein the vinylidene chloride interpolymer is from about 50 to about 90 weight percent vinylidene chloride and from about 50 to about 10 weight percent vinyl chloride, based on total weight of the vinylidene chloride interpolymer.

22. The invention of any of claims 1-21 wherein the amount of copolymer of olefin and alkyl ester of unsaturated carboxylic acid is from 1 to 10 weight percent of the interpolymer composition.

23. The invention of any of claims 1-22 wherein the amount of copolymer of olefin and alkyl ester of unsaturated carboxylic acid is from 0.1 to 3 weight percent of the interpolymer composition.

24. The invention of any of claims 1-23 wherein the amount of copolymer of olefin and alkyl ester of unsaturated carboxylic acid is from 1 to 3 weight percent of the interpolymer composition.

25. The invention of any of claims 1-24 wherein the vinylidene chloride interpolymer composition is in the form of a monolayer film with a thickness of from about 3 micron (3×10⁻⁶ m) to about 120 micron (120×10⁻⁶ m).

26. The invention of any of claims 1-25 wherein the vinylidene chloride interpolymer composition is in the form of a monolayer film with a thickness of from about 3 micron (3×10⁻⁶ m) to about 80 micron (80×10⁻⁶ m).
